(19) United States
(12) Patent Application Publication
(10) Pub. No.: US 2015/0015198 A1
(43) Pub. Date: Jan. 15, 2015

(54) WIRELESS CHARGING DEVICE AND METHOD FOR CONTROLLING WIRELESS CHARGING

(71) Applicants: Hiroki OKADA, (US); Hiroko MURAKAMI, (US); KABUSHIKI KAISHA TOKAI RIKA DENKI SEISAKUSHO, Aichi (JP)

(72) Inventors: Hiroki Okada, Toyota-shi (JP); Hiroko Murakami, Toyota-shi (JP); Naoki Watanabe, Aichi (JP); Hidenobu Hanaki, Aichi (JP)

(73) Assignee: TOYOTA JIDOSHA KABUSHIKI KAISHA, Aichi-ken (JP)

(21) Appl. No.: 14/373,241

(22) PCT Filed: Jan. 31, 2013
(86) PCT No.: PCT/JP2013/000533

§ 371 Date: Jul. 18, 2014

(30) Foreign Application Priority Data
Feb. 17, 2012 (JP) 2012-032957

(51) Int. Cl. H02J 7/02; H02J 7/00

(52) U.S. Cl. CPC H02J 7/025; H02J 7/007; H02J 2007/0001
USPC 320/108

(57) ABSTRACT

A wireless charging device (40) arranged in a vehicle including an in-vehicle device (20). The in-vehicle device transmits a wake signal in intervals until receiving a response from an electronic key (10) and communicates with the electronic key when receiving the response to determine whether the electronic key is authentic. The wireless charging device includes a primary coil (L1) that transmits power to a charged device (50) when supplied with alternating current. A detection unit (43) uses the wake signal to detect when communication starts between the in-vehicle device and the electronic key. A power supplying suppression unit (43) reduces the alternating current supplied to the primary coil over a certain time from when the communication starts. The power supplying suppression time includes the time required for a series of communication to be performed between the in-vehicle device and the electronic key for the verification.

### TECHNICAL FIELD

The present invention relates to a wireless charging device, which performs wireless charging on a charged device, and a method for controlling wireless charging.

### BACKGROUND ART

A wireless charging system transmits power from a charging device to a charged device in a wireless manner to charge the charged device (refer to, for example, Japanese Laid-Open Patent Publication No. 2008-5573). More specifically, the charging device includes a primary coil, and the charged device includes a secondary coil. The charged device is set on a power transmission pad, which is formed on an upper surface of the charging device. When excited, the primary coil generates low-frequency radio waves (electromagnetic waves), which induce power at the secondary coil. The power charges a battery that is incorporated in the charged device.

It is expected that many charging devices will be manufactured in compliance with a standard set by the Wireless Power Consortium (WPC), which is an association of organizations related to wireless charging systems. The standard designates frequencies from 100 kHz to 200 kHz for the radio waves from the primary coil.

Japanese Laid-Open Patent Publication No. 2004-92071 describes a vehicle provided with an electronic key system that performs wireless communication between the vehicle and an electronic key to enable the locking and unlocking of vehicle doors and the starting of the engine. In the electronic key system, the vehicle transmits radio waves on the low frequency (LF) band (e.g., 134 kHz or 125 kHz) to the electronic key.

In this manner, a wireless charging system and an electronic key system use frequencies that are in the same range. Thus, when such a charging device is set in a vehicle, radio wave interference may occur between the wireless charging system and the electronic key system. More specifically, when the charging device is used inside the vehicle, the radio waves from the charging device may act as noise on the electronic key system. The noise may adversely affect wireless communication between the electronic key and the vehicle and thereby impede the starting of the engine. Thus, when setting a wireless charging device in a vehicle, it is desirable that the influence of the wireless charging device on the communication of the electronic key system be minimized for user convenience.

### SUMMARY OF INVENTION

It is an object of the present invention to provide a wireless charging device and a method for controlling wireless charging that minimize the influence on communication of an electronic key system.

One aspect of the present invention is a wireless charging device arranged in a vehicle including an in-vehicle device. The in-vehicle device transmits, in a wireless manner, a wake signal for a number of times in intervals of a first time until receiving a response from an electronic key, and the in-vehicle device performs a series of communication with the electronic key when receiving the response to determine whether or not the electronic key is authentic. The wireless charging device includes a primary coil that transmits power in a wireless manner to a charged device when supplied with alternating current. A detection unit uses the wake signal to detect when communication starts between the in-vehicle device and the electronic key. A power supplying suppression unit reduces the alternating current supplied to the primary coil over a power supplying suppression time from when the starting of the communication is detected by the detection unit. The power supplying suppression time includes a time required for a series of communication to be performed between the in-vehicle device and the electronic key for the verification.

In this structure, when the power supplying suppression unit detects a wake signal from the in-vehicle device with the detection unit, the power supplying suppression unit reduces the alternating current supplied to the primary coil over the power supplying suppression time. The power supplying suppression time includes the time required for the series of communication to be performed between the in-vehicle device and the electronic key. This effectively reduces the electromagnetic waves from the wireless charging device that may impede with the communication between the in-vehicle device and the electronic key.

After verifying that the electronic key is authentic through the series of communication performed with the electronic key, the in-vehicle device may further verify the electronic key by performing a series of communication with the electronic key for a number of times in intervals of a second time. The power supplying suppression time may include the time required for performing the series of communication for the number of times between the in-vehicle device and the electronic key.

In this structure, the power supplying suppression time is set to include the time required for performing the series of communication for the number of times between the in-vehicle device and the electronic key. Thus, in an electronic key system that verifies the electronic key in intervals of the second time, electromagnetic waves from the contactless charging device does not impede the series of communication performed a number of times.

A second aspect of the present invention is a method for controlling wireless charging with an in-vehicle device and a wireless charging device arranged in a vehicle. The in-vehicle device transmits, in a wireless manner, a wake signal for a number of times in intervals of a first time until receiving a response from an electronic key and performs a series of communication with the electronic key when receiving the response to determine whether or not the electronic key is authentic. The wireless charging device includes a primary coil that transmits power in a wireless manner to a charged device when supplied with alternating current. The method includes detecting with the wake signal when communication starts between the in-vehicle device and the electronic key, and reducing the alternating current supplied to the primary coil over a power supplying suppression time from when the starting of the communication is detected. The power supplying suppression time includes a time required for a series of communication to be performed between the in-vehicle device and the electronic key for the verification.

The present invention suppresses the influence on communication of an electronic key system.

Other aspects and advantages of the present invention will become apparent from the following description, taken in conjunction with the accompanying drawings, illustrating by way of example the principles of the invention.

### BRIEF DESCRIPTION OF DRAWINGS

FIG. 1 is a schematic block diagram of a vehicle and an electronic key according to a first embodiment of the present invention.

FIG. 2 is a timing chart showing a series of communication performed between an in-vehicle device and an electronic key in the first embodiment of the present invention.

FIG. 3 is a schematic perspective view showing a wireless charging device in a state in which a portable terminal is set on a power transmission pad in the first embodiment of the present invention.

FIG. 4 is a timing chart showing a power supplying suspension period of the wireless charging device and wireless signals transmitted from the in-vehicle device in the first embodiment of the present invention.

FIG. 5 is a timing chart showing a power supplying suspension period of a wireless charging device and wireless signals transmitted from an in-vehicle device in a second embodiment of the present invention.

### DESCRIPTION OF EMBODIMENT

### First Embodiment

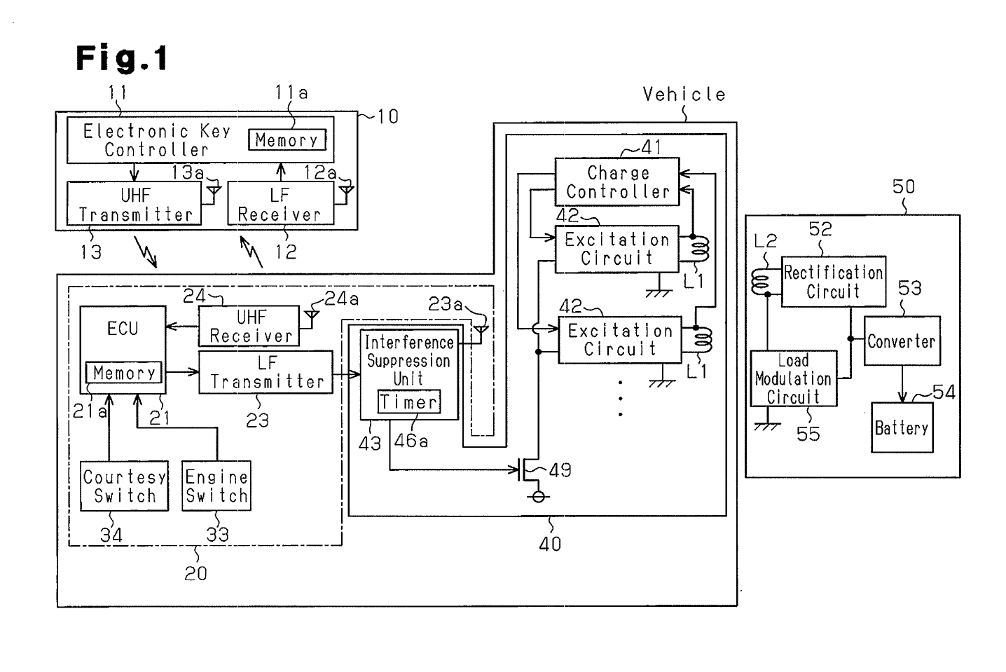

A wireless charging device according to a first embodiment of the present invention will now be discussed with reference to FIGS. 1 to 4.

Referring to FIG. 1, a vehicle includes a wireless charging device 40 and an in-vehicle device 20. The in-vehicle device 20 performs communication with an electronic key 10, which is carried by a user, to permit starting of the engine. The wireless charging device 40 can charge a portable terminal 50, which is carried by the user, in a wireless manner. The structures of the electronic key 10, the in-vehicle device 20, the wireless charging device 40, and the portable terminal 50 will now be described in detail.

Electronic Key

The electronic key 10 includes an electronic key controller 11, an LF receiver 12, and an UHF transmitter 13. The electronic key controller 11 is formed by a computer unit, which includes a CPU, and is connected to the LF receiver 12 and the UHF transmitter 13. The LF receiver 12 is connected to a receiver antenna 12a and receives wireless signals on the low frequency (LF) band. The UHF transmitter 13 is connected to a transmitter antenna 13a and transmits wireless signals on the ultrahigh frequency (UHF) band. The electronic key controller 11 includes a memory 11a, which stores a vehicle ID code, a key ID code, and an encryption key.

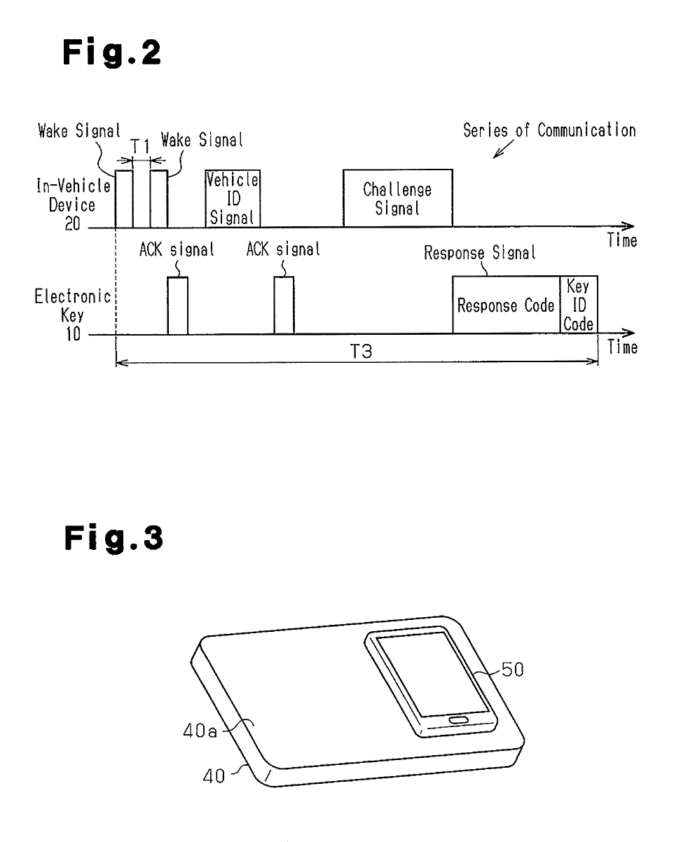

Referring to FIG. 2, the LF receiver 12 of the electronic key 10 receives a wake signal on the LF band from the in-vehicle device 20 with the receiver antenna 12a. The LF receiver 12 demodulates the wake signal to a pulse signal and provides the demodulated wake signal to the electronic key controller 11.

Upon recognition of the wake signal, the electronic key controller 11 generates an acknowledgement (ACK) signal and provides the generated acknowledgement signal to the UHF transmitter 13. The UHF transmitter 13 modulates the acknowledgement signal and transmits the modulated acknowledgement signal with the transmitter antenna 13a as a wireless signal on the UHF band.

The LF receiver 12 receives a vehicle ID signal from the in-vehicle device 20 with the receiver antenna 12a. The LF receiver 12 demodulates the vehicle ID signal to a pulse signal and provides the demodulated vehicle ID signal to the electronic key controller 11. Upon recognition of the vehicle ID signal, the electronic key controller 11 verifies a vehicle ID code included in the vehicle ID signal with the vehicle ID code stored in the memory 11a (vehicle ID verification). When determining that vehicle ID code verification is accomplished, the electronic key controller 11 transmits an acknowledgement signal in the same manner as described above.

The LF receiver 12 receives a challenge signal with the receiver antenna 12a. Then, the LF receiver 12 demodulates the challenge signal to a pulse signal and provides the demodulated challenge signal to the electronic key controller 11. Upon recognition of the challenge signal, the electronic key controller 11 encrypts a challenge code included in the challenge signal using the encryption key stored in the memory 11a to generate a response signal and provides the generated response signal to the UHF transmitter 13. The UHF transmitter 13 modulates the response signal and transmits the modulated response signal with the transmitter antenna 13a as a wireless signal on the UHF band.

In-Vehicle Device

Referring to FIG. 1, the in-vehicle device 20 includes an electronic control unit (ECU) 21, a UHF receiver 24, a LF transmitter 23, an engine switch 33, and a courtesy switch 34. The ECU 21, which is formed by a computer unit, is connected to the UHF receiver 24 and the LF transmitter 23. The UHF receiver 24 receives wireless signals on the UHF band. The LF transmitter 23 transmits wireless signals on the LF band. The LF transmitter 23 is connected by an interference suppression unit 43, which is included in the wireless charging device 40, to an LF transmitter antenna 23a. The interference suppression unit 43 includes a timer 46a. The structure and operation of the interference suppression unit 43 will be described later.

As shown in FIG. 1, the ECU 21 is connected to an engine switch 33 and a courtesy switch 34. The courtesy switch 34 detects when a vehicle door opens and closes and provides the ECU 21 with the detection result. The engine switch 33 is arranged in the vicinity of the driver seat and can be pushed by the user. When pushed, the engine switch 33 provides the ECU 21 with an operation signal indicating that the engine switch 33 has been pushed.

The ECU 21 includes a non-volatile memory 21a. The memory 21a stores a key ID code and vehicle ID code, which are identical to those of the authentic electronic key 10, and an encryption key.

When determining, for example, with the courtesy switch 34 that the vehicle door has been opened and closed, the ECU 21 generates a wake signal to determine whether or not the electronic key 10 has been carried out of the vehicle. Then, the ECU 21 provides the generated wake signal to the LF transmitter 23. The LF transmitter 23 modulates the wake signal from the ECU 21 and transmits the modulated wake signal to the interior of the vehicle with the LF transmitter antenna 23a.

The UHF receiver 24 is connected to a receiver antenna 24a and receives an acknowledgement signal, which is transmitted from the electronic key 10 in response to a wake signal, with the receiver antenna 24a. The UHF receiver 24 demodulates the received acknowledgement signal to a pulse signal and provides the demodulated acknowledgement signal to the ECU 21. Upon recognition of the acknowledgement signal, the ECU 21 generates a vehicle ID signal, which includes the vehicle ID code stored in the memory 21a, and provides the generated vehicle ID signal to the LF transmitter 23. The LF transmitter 23 modulates the vehicle ID signal and transmits the modulated vehicle ID signal with the LF transmitter antenna 23a as a wireless signal on the LF band.

Referring to FIG. 2, when the ECU 21 of the in-vehicle device 20 cannot recognize an acknowledgement signal from the electronic key 10 after transmitting a first wake signal, the ECU 21 transmits a wake signal again after a predetermined time T1 elapses from the transmission of the first wake signal. The transmission of the wake signal may be performed a number of times.

The UHF receiver 24 receives an acknowledgement signal, which is transmitted from the electronic key 10 in response to the vehicle ID signal, with the receiver antenna 24a. The UHF receiver 24 demodulates the received acknowledge signal to a pulse signal and provides the demodulated acknowledgement signal to the ECU 21. Upon recognition of the acknowledgement signal, the ECU 21 generates a challenge signal, which includes a challenge code, and provides the challenge signal to the LF transmitter 23. The LF transmitter 23 modulates the challenge signal and transmits the modulated challenge signal with the LF transmitter antenna 23a as a wireless signal on the LF band. Here, the ECU 21 encrypts the challenge code with the encryption key stored in the memory 21a to generate a response code.

The UHF receiver 24 receives a response signal with the receiver antenna 24a. Then, the UHF receiver 24 demodulates the response signal and provides the demodulated response signal to the ECU 21. Upon recognition of the response signal, the ECU 21 verifies the key ID code included in the response signal with the key ID code stored in the memory 21a (key ID verification). Further, the ECU 21 verifies the response code included in the response signal with the response code generated by the ECU 21 (response verification). When determining that the key ID verification and response verification are accomplished, the ECU 21 is in a verification accomplishment state. The transmission and reception of the wake signal, acknowledgement signal, vehicle ID, challenge signal, and response signal between the electronic key 10 and the in-vehicle device 20 is referred to as a “series of communication.” As shown in FIG. 2, time T3 is required for the series of communication.

When the ECU 21 does not receive a reply to a wake signal, vehicle signal, or challenge signal due to the influence of ambient noise or the like, the ECU 21 retransmits the wake signal, vehicle signal, or challenge signal. The retransmission of the challenge signal or response signal may be performed a number of times. Thus, the length of the time T3 required for the series of communication varies in accordance with the number of transmissions of the wake signal, challenge signal, and response signal.

The number of times the verifications described above are performed varies in accordance with the situation of the vehicle. In this example, the ECU 21 determines that the user has left the vehicle when the courtesy switch 34 detects the opening and closing of the vehicle door. In this case, the key ID verification and the response verification (i.e., the series of communication) are both performed once by the ECU 21 to determine whether or not the electronic key 10 has been carried out of the vehicle. When determining that the key ID verification and response verification have both been accomplished, the ECU 21 presumes that the electronic key 10 is located in the vehicle and prohibits the locking of the vehicle door. When determining that the key ID verification and response verification have both been unaccomplished, the ECU 21 presumes that the electronic key 10 is not located in the vehicle and permits the locking of the vehicle door. This prevents the electronic key 10 from being locked inside the vehicle. Verification triggered in such a manner by an event (in this example, the opening and closing of the vehicle door after the engine is stopped) is referred to as event verification.

Wireless Charging Device and Portable Terminal

Referring to FIG. 3, the wireless charging device 40 includes a power transmission pad 40a having an upper surface on which the portable terminal 50 can be set. The wireless charging device 40 is arranged in the vehicle with the power transmission pad 40a in an exposed state. The user can charge the portable terminal 50 just by placing the portable terminal 50 on the power transmission pad 40a.

Referring to FIG. 1, in addition to the interference suppression unit 43, the wireless charging device 40 includes a charge controller 41, excitation circuits 42, and primary coils L1, the number of which is the same as the excitation circuits 42.

The portable terminal 50 includes a secondary coil L2, a rectification circuit 52, a converter 53, a battery 54, and a load modulation circuit 55.

The primary coils L1 are arranged along the power transmission pad 40a in the wireless charging device. The primary coils L1 are spiral coils. Each primary coil L1 is connected to a corresponding one of the excitation circuits 42. Further, each excitation circuit 42 is connected between a power supply and ground.

The charge controller 41 supplies alternating current to each primary coil L1 through the excitation circuit 42. This excites the primary coil L1 and generates radio waves (electromagnetic waves). As described above in the background art section, the WPC standard designates frequencies from 100 kHz to 200 kHz for the radio waves. The charge controller 41 monitors the current supplied to the primary coil L1.

When the portable terminal 50 is set on the power transmission pad 40a, the axis of the secondary coil L2 is orthogonal to the surface of the power transmission pad 40a. The secondary coil L2 induces current with the electromagnetic waves from the primary coils L1 (electromagnetic induction). The rectification circuit 52 converts the induced alternating current to direct current and supplies the converted current to the converter 53. The converter 53 increases or decreases power and supplies the power to the battery 54. This charges the battery 54.

The charge controller 41 performs polling to determine whether or not the portable terminal 50 is set on the power transmission pad 40a. More specifically, the charge controller 41 intermittently supplies alternating current to each primary coil L1 to excite the primary coil L1. This transmits a polling signal (radio waves) from the primary coil L1.

The load modulation circuit 55 of the portable terminal 50 performs load modulation when receiving the polling signal with the secondary coil L2. In detail, upon receipt of the polling signal, the load modulation circuit 55 switches between a connection state, in which a load (not shown) is connected to the secondary coil L2, and a disconnection state, in which the load is disconnected from the secondary coil L2. For example, when switched to the connection state, the impedance of the primary coil that is magnetically coupled to the secondary coil L2 is changed from that of the disconnection state. This changes the current supplied to the primary coil L1. The charge controller 41 determines from the change in current that the portable terminal 50 has been placed on the power transmission pad 40a. When determining that the portable terminal 50 has been set on the power transmission pad 40a, the charge controller 41 continuously excites the primary coil L1 to actually charge the portable terminal 50.

A field effect transistor (FET) 49 including a drain terminal and a source terminal is connected between the power supply and the excitation circuits 42. The FET 49 is normally switched on, and each excitation circuit 42 is supplied with power from the power supply. The interference suppression unit 43 applies voltage to the gate terminal (control terminal) of the FET 49. This disconnects the drain terminal and source terminal and switches off the FET 49.

The structure and operation of the interference suppression unit 43 will now be described.

As shown in FIG. 1, the interference suppression unit 43 includes a timer 46a. When detecting an LF signal (wake signal) from the LF transmission 23, the interference suppression unit 43 determines that the series of communication has started and actuates the timer 46a, which measures a power supplying suspension time Ts1. Further, the interference suppression unit 43 applies voltage to the base terminal of the FET 49 until the power supplying suspension time Ts1 elapses. This suspends the supply of power to each excitation circuit 42 and stops the transmission of electromagnetic waves from the wireless charging device 40.

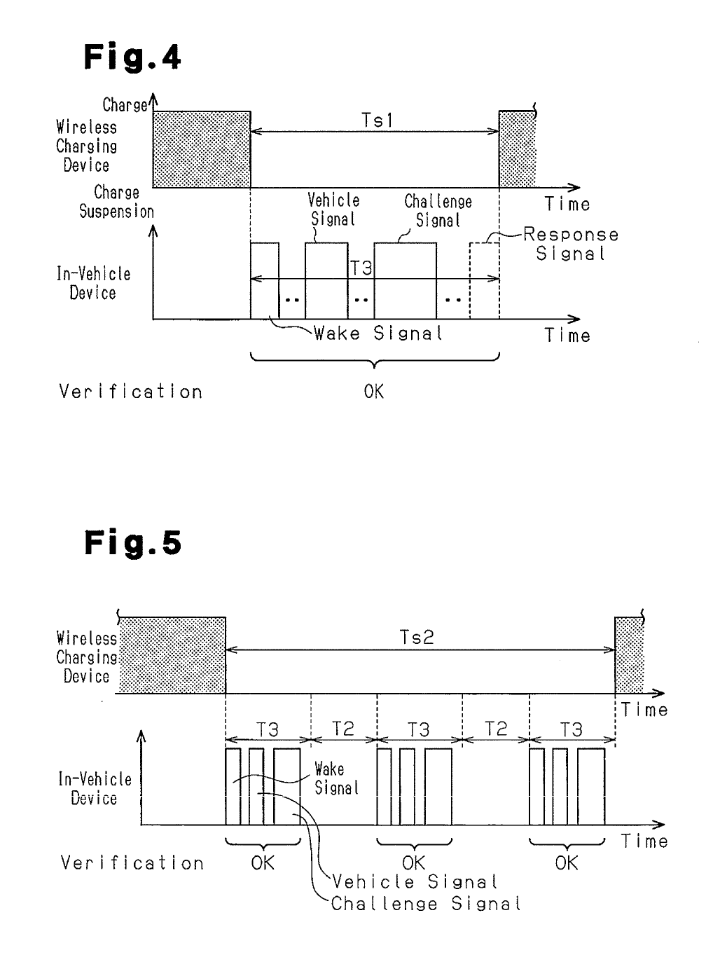

Referring to FIG. 4, the power supplying suspension time Ts1 is set in conformance with the time T3 required for the series of communication, which is started upon detection of the wake signal. As described above, the length of the time T3 varies in accordance with the number of transmissions of the wake signal, vehicle signal, and challenge signal. Hence, the power supplying suspension time Ts1 is set in conformance with the longest time T3 required for the series of communication. This effectively suppresses interference in communication performed between the in-vehicle device 20 and the electronic key 10.

The first embodiment has the following advantage.

Upon detection of a wake signal, the interference suppression unit 43 reduces alternating current supplied to the primary coils L1 over the power supplying suspension time Ts1. The power supplying suspension time Ts1 is set to include the time T3, which is required for the series of communication between the in-vehicle device 20 and the electronic key 10. This minimizes the power supplying suspension time Ts1 and effectively suppresses the generation of electromagnetic waves from the wireless charging device 40 when there is a possibility of the communication between the in-vehicle device 20 and the electronic key 10 being interfered by the electromagnetic waves.

### Second Embodiment

A wireless charging device according to a second embodiment of the present invention will now be described with reference to FIG. 5. The second embodiment differs from the first embodiment in how the power supplying suspension time is set. The description hereafter will focus on the differences between the first and second embodiments.

When the user enters the vehicle and the ECU 21 determines with the courtesy switch 34 that the vehicle door has been opened and closed, the ECU 21 performs the series of communication (verification) for a number of times to determine whether or not the authentic electronic key 10 is located in the vehicle. In this case, as shown in FIG. 5, when a first verification is accomplished, the ECU 21 further performs the series of communication (verification) after an interval of a predetermined time T2.

In a verification accomplishment state, when recognizing that the engine switch 33 has been operated, the ECU 21 starts the engine. Verification performed in this manner before a user operation is referred to as an advanced verification.

The wake signal for the first series of communication actuates the timer 46a, which measures a power supplying suspension time Ts2. Further, the interference suppression unit 43 applies voltage to the base terminal of the FET 49 until the power supplying suspension time Ts2 elapses. This suspends the supply of power to each excitation circuit 42 and stops the transmission of electromagnetic waves from the wireless charging device 40.

The power supplying suspension time Ts2 is set to include the time required for performing communication for a number of times between the in-vehicle device 20 and the electronic key 10. More specifically, the power supplying suspension time Ts2 is set as “time T3 required for series of communication multiplied by number of times of communication+predetermined time T2 multiplied by (number of times of communication−1).” In the same manner as the first embodiment, the time T3 is set as the longest time required for the series of communication. In the example of FIG. 5, the power supplying suspension time Ts2 is set as “time T3 required for series of communication multiplied by 3+predetermined time T2 multiplied by 2.”

The second embodiment has the following advantage.

The power supplying suspension time Ts2 is set to include the time T3 required for performing the series of communication a number of times between the in-vehicle device 20 and the electronic key 10. Thus, in a system that verifies the electronic key 10 whenever the predetermined time T2 elapses, the power supplying suspension time Ts2 is minimized, and the series of communication performed a number of times between the in-vehicle device 20 and the electronic key 10 is not interfered by the electromagnetic waves generated by the wireless charging device 40.

It should be apparent to those skilled in the art that the present invention may be embodied in many other specific forms without departing from the spirit or scope of the invention. Particularly, it should be understood that the present invention may be embodied in the following forms.

In the first and second embodiments, the interference suppression unit 43 is wire-connected to the LF transmitter 23 and the LF transmitter antenna 23a. However, an interference suppression unit may be formed independently from the LF transmitter 23 and the LF transmitter antenna 23a. Such an interference suppression unit applies voltage to the base terminal of the FET 49 over the power supplying suspension time Ts1 or Ts2. In the same manner as the first and second embodiments, this prevents the transmission of power from the wireless charging device 40 to the portable terminal 50 from interfering with the communication performed between the electronic key 10 and the in-vehicle device 20.

In the first and second embodiments, the FET 49 is switched off to stop the generation of electromagnetic waves from the wireless charging device 40. However, there is no limitation to such a configuration as long as the generation of electromagnetic waves from the wireless charging device 40 can be stopped. For example, the power supply for the entire wireless charging device 40 may be deactivated. Such a configuration would easily stop the generation of electromagnetic waves from the wireless charging device 40.

Further, for example, a relay circuit may be arranged between each excitation circuit 42 and the corresponding primary coil L1. The relay circuit includes first to third terminals. The first terminal is connected to the excitation circuit 42, the second terminal is connected to the primary coil L1, and the third terminal is connected to ground. A movable contact is switched between the second and third terminal to connect the primary coil L1 to either one of the excitation circuit 42 and ground. When detecting an LF signal, the interference suppression unit 43 connects the primary coil L1 to ground with the relay circuit over a predetermined time. This stops the generation of electromagnetic waves from the wireless charging device 40.

Moreover, the impedance of an antenna system including primary coils L1 may be increased to suppress the electromagnetic waves from the primary coil L1. In detail, a matching circuit can be arranged between each excitation circuit 42 and the corresponding primary coil L1. The matching circuit matches the impedance of the primary coil with that of a power line to suppress reflection loss in the electric energy of the antenna system that includes the primary coil L1. When determining that the voltage is greater than or equal to a threshold value, the interference suppression unit 43 increases the impedance of the antenna system with the matching circuit over a predetermined time. This decreases the alternating current supplied to the primary coil L1 and consequently suppresses the electromagnetic waves generated from the primary coil L1.

In the first and second embodiments, when a wake signal is transmitted to the interior of the vehicle from the LF transmitter antenna 23a, the generation of electromagnetic waves from the wireless charging device 40 is suppressed. However, the generation of electromagnetic waves from the wireless charging device 40 may also be suppressed when a wireless signal is transmitted from a transmitter antenna arranged outside the vehicle (e.g., in a door handle). For example, in an event verification, when a lock switch arranged in an outside door handle is operated, the in-vehicle device 20 transmits a wake signal to the exterior of the vehicle. When a series of communication with the electronic key 10 started with the wake signal is accomplished, the in-vehicle device 20 switches the vehicle door between locked and unlocked states. In an advanced verification, the in-vehicle device 20 transmits a wake signal to the exterior of the vehicle in predetermined cycles, and the in-vehicle performs a series of communication with the electronic key 10 when the electronic key 10 is located in the vicinity of the vehicle. When the verification is accomplished and the lock switch is operated, the in-vehicle device switches the vehicle door between locked and unlocked states. This would also obtain the same advantages as the first and second embodiments by setting the power supplying suspension times Ts1 and Ts2 in accordance with the event verification and advanced verification.

In the first and second embodiments, the wireless charging device 40 is of an electromagnetic induction type but may be of a magnetic field resonance type.

In the second embodiment, the cycle of the series of communication (verification) may be varied in accordance with whether or not verification is accomplished. For example, when determining that verification cannot be accomplished a predetermined number of times, the ECU 21 performs the series of communication after a predetermined time, which is shorter than the predetermined time T2, elapses thereafter.

In the first and second embodiments, the power supplying suspension time is fixed but may be set in conformance with either one of the power supplying suspension times Ts1 and Ts2 based on a determination of whether it is for event verification or advanced verification. In this case, the interference suppression unit 43 obtains vehicle information (engine information, vehicle door information, and the like) from the ECU 21 and determines whether or not the series of communication is for event verification or advanced verification. Then, the interference suppression unit 43 sets the power supplying suspension time to either one of the power supplying suspension times Ts1 and Ts2 in accordance with the determination result. Further, the interference suppression unit 43 may directly receive the detection result from the engine switch 33 or the courtesy switch 34.

In the above embodiments, the longest time T3 required for the series of communication is used to set the power supplying suspension times Ts1 and Ts2. However, the time T3 does not have to be the longest time required for the series of communication used to set the power supplying suspension times Ts1 and Ts2.

Accordingly, in a wireless charging device according to the present invention, the vehicle may include an engine switch operated when starting the engine, and the in-vehicle device may start the vehicle engine when detecting the operation of the engine switch during a period in which verification of the electronic key is accomplished.

In a wireless charging device according to the present invention, the in-vehicle device may transmit a wake signal when the user performs a certain operation with the vehicle.

The present examples and embodiments are to be considered as illustrative and not restrictive, and the invention is not to be limited to the details given herein, but may be modified within the scope and equivalence of the appended claims.

1. A wireless charging device arranged in a vehicle including an in-vehicle device, wherein the in-vehicle device transmits, in a wireless manner, a wake signal for a number of times in intervals of a first time until receiving a response from an electronic key, and the in-vehicle device performs a series of communication with the electronic key when receiving the response to determine whether or not the electronic key is authentic, the wireless charging device comprising:
a primary coil that transmits power in a wireless manner to a charged device when supplied with alternating current;
a detection unit that uses the wake signal to detect when communication starts between the in-vehicle device and the electronic key; and
a power supplying suppression unit that reduces the alternating current supplied to the primary coil over a power supplying suppression time from when the starting of the communication is detected by the detection unit,
wherein the power supplying suppression time includes a time required for a series of communication to be performed between the in-vehicle device and the electronic key for the verification.

2. The wireless charging device according to claim 1, wherein
after verifying that the electronic key is authentic through the series of communication performed with the electronic key, the in-vehicle device further verifies the electronic key by performing a series of communication with the electronic key for a number of times in intervals of a second time,
the power supplying suppression time includes the time required for performing the series of communication for the number of times between the in-vehicle device and the electronic key.

3. The charging device according to claim 1, further comprising:
an excitation circuit connected to the primary coil;
a field effect transistor including a first terminal, which is connected to the excitation circuit, a second terminal, which is connected to a power supply, and a control terminal, which is connected to the power supplying suppression unit;
wherein the power supplying suppression unit is configured to apply voltage to the control terminal of the field effect transistor over the power supplying suspension time from when the communication starts to reduce power that is supplied to the excitation circuit.

4. The charging device according to claim 1, wherein the series of communication includes reception and transmission of the wake signal, an acknowledgement signal, a vehicle ID signal, a challenge signal, and a response signal between the electronic key and the in-vehicle device.

5. A method for controlling wireless charging with an in-vehicle device and a wireless charging device arranged in a vehicle, wherein the in-vehicle device transmits, in a wireless manner, a wake signal for a number of times in intervals of a first time until receiving a response from an electronic key and performs a series of communication with the electronic key when receiving the response to determine whether or not the electronic key is authentic, and the wireless charging device includes a primary coil that transmits power in a wireless manner to a charged device when supplied with alternating current, the method comprising:
detecting with the wake signal when communication starts between the in-vehicle device and the electronic key; and
reducing the alternating current supplied to the primary coil over a power supplying suppression time from when the starting of the communication is detected,
wherein the power supplying suppression time includes a time required for a series of communication to be performed between the in-vehicle device and the electronic key for the verification.

6. The method according to claim 5, wherein
after verifying that the electronic key is authentic through the series of communication performed with the electronic key, the in-vehicle device further verifies the electronic key by performing a series of communication with the electronic key for a number of times in intervals of a second time,
the power supplying suppression time includes the time required for performing the series of communication for the number of times between the in-vehicle device and the electronic key.

7. The method according to claim 5, wherein the wireless charging device includes:
an excitation circuit connected to the primary coil;
a field effect transistor including a first terminal, which is connected to the excitation circuit, a second terminal, which is connected to a power supply, and a control terminal, which is connected to the power supplying suppression unit;
wherein the reducing the alternating current includes applying voltage to the control terminal of the field effect transistor over the power supplying suspension time from when the communication starts to reduce power that is supplied to the excitation circuit.

8. The method according to claim 5, wherein the series of communication includes reception and transmission of the wake signal, an acknowledgement signal, a vehicle ID signal, a challenge signal, and a response signal between the electronic key and the in-vehicle device.
